(19) United States
(12) Patent Application Publication
(10) Pub. No.: US 2026/0290733 A1
(43) Pub. Date: Sep. 24, 2026

(54) PYROTECHNIC CIRCUIT BREAKER

(71) Applicant: Autoliv Development AB, Vargarda (SE)

(72) Inventors: Benjamin DUVERT, Chambly (FR); Fabiene LAMY, Taverny (FR); Maxime GRANDIAU, Thiescourt (FR)

(21) Appl. No.: 19/472,985

(22) PCT Filed: Apr. 4, 2024
(86) PCT No.: PCT/EP2024/059119

§ 371 Date: Oct. 6, 2025

(30) Foreign Application Priority Data
Apr. 6, 2023 (FR) FR2303447

(51) Int. Cl. H01H 39/00

(52) U.S. Cl. CPC H01H 39/006

(57) ABSTRACT

A pyrotechnic circuit breaker, including at least a housing, an electrical conductor to be cut, a cutting piston, movable between a rest position and an activated position, the cutting piston being arranged to cut the electrical conductor during its movement from the rest position to the activated position, a pyrotechnic actuator, housed in the housing and arranged to cause the cutting piston to pass from the rest position to the activated position during its operation, where the circuit breaker including at least one deformable member, arranged to brake the cutting piston once the electrical conductor has been cut, and in that a strictly positive clearance is provided between the deformable member and the electrical conductor before it is cut.

### TECHNICAL FIELD OF THE INVENTION

The present invention generally relates to a pyrotechnic circuit breaker intended to be mounted for example on an automotive vehicle.

### PRIOR ART

Circuit-breaker devices are known in the prior art, such as the one described in document DE 102022113300 A1, which offers a deformable piston braking device that evacuates the hot gases generated by arcs when the conductor is cut. However, this braking system can have the disadvantage of lengthening the time during which arcs can be established, as the piston speed decreases before the electrical conductor is completely cut, presenting a greater risk of damage to the device. In addition, as the piston is subjected to the resistance of both the conductor and the deformable body during cutting, the cutting process is more variable.

### DISCLOSURE OF THE INVENTION

One aim of the present invention is to overcome the above-mentioned drawbacks of the prior art and in particular, firstly, to offer a circuit breaker with a high cutting speed so as to reach a maximum arc length as quickly as possible when current flows through the circuit breaker, and/or whose cut-off is repeatable, and/or whose housing is less sensitive to a possible shock to the piston at the end of the stroke.

A first aspect of the invention therefore relates to a pyrotechnic circuit breaker, comprising at least:
a housing,
an electrical conductor to be cut, passing at least partially through the housing,
a cutting piston, housed in the housing and movable between a rest position and an activated position, the cutting piston being arranged to cut the electrical conductor during its movement from the rest position to the activated position,
a pyrotechnic actuator, housed in the housing and arranged to cause the cutting piston to pass from the rest position to the activated position during its operation, characterized in that the circuit breaker comprises at least one deformable member, arranged to brake the cutting piston once the electrical conductor has been cut,
   and in that a strictly positive clearance is provided between the deformable member and the electrical conductor before it is cut. According to the above embodiment, a clearance is provided between the electrical conductor and the deformable member, so that when the electrical conductor is cut, the deformable member does not undergo any force: the cut is faster and less variable.

According to one embodiment, the cutting piston passes through a contact position during its movement from the rest position to the activated position, wherein the contact position is a position wherein the cutting piston is in contact with the electrical conductor before being cut, and wherein a strictly positive clearance is provided between the deformable member and the cutting piston in the contact position. According to the above embodiment, a clearance is provided between the deformable member and the cutting piston when the latter beings to contact the electrical conductor, so that when the electrical conductor is cut, the deformable member does not undergo any force: the cut is faster and less variable. In other words, a clearance can exist between the cutting piston and the deformable member when the cutting piston is in the contact position, so that the cutting piston is not subjected to the resisting force of the deformable member during cutting.

According to one embodiment, the strictly positive clearance between the deformable member and the cutting piston in the contact position may be a clearance strictly greater than a thickness of the electrical conductor to be cut, so that the cutting piston has completely cut the electrical conductor before slowing down by deforming the deformable member.

According to one embodiment, the cutting piston can be arranged to shear the electrical conductor.

According to one embodiment, the cutting piston may travel:
a free stroke before cutting the electrical conductor, and
a damped stroke during which the deformable member is deformed, for which a ratio of free stroke to damped stroke of the piston can be greater than or equal to 1.2, and preferably greater than 1.5. The free distance may be greater than the damped distance. The applicant found that cutting was fast and repeatable with such a minimum ratio, while minimizing impacts on the housing. In fact, it should be noted that the cutting piston needs to pick up enough speed to cut the electrical conductor properly, and this can be sufficiently damped with the aforementioned ratio.

According to one embodiment, the piston may travel:
an undamped stroke after cutting the electrical conductor, and
a damped stroke during which the deformable member is deformed, and for which a ratio of the undamped stroke to the damped stroke can be greater than or equal to 0.6, preferably greater than 0.75 and even more preferentially greater than 0.85. The applicant found that cutting was fast and repeatable with such a minimum ratio, while minimizing impacts on the housing. Indeed, it may be noted that the cutting piston must still travel a certain undamped stroke after the cut to guarantee a minimum distance between cut ends of the electrical conductor before being damped, to perform its damped stroke according to the aforementioned ratio. This ensures that the minimum distance between the cut ends of the electrical conductor is reached as quickly as possible.

According to one embodiment, the deformable member can be arranged to be deformed directly by the cutting piston. Cutting variability is reduced by direct contact between the deformable member and the cutting piston: no intermediate components interfere with operation. In other words, the cutting piston comprises a contact portion dedicated to directly contacting the deformable member once the electrical conductor has been cut. The housing can also be fitted with a special, obstacle-or component-free passage between the cutting piston and the deformable member.

According to one embodiment, the deformable member may be separate from the cutting piston and/or housing. According to this embodiment, the deformable member can be a member at least partially mounted in the housing and dedicated to the damping function of the cutting piston.

According to one embodiment, the deformable member can be arranged to form part of the cutting piston or the housing. According to this embodiment, the deformable member can be an attached member or integrated into the cutting piston or housing. Deformable lugs can be formed directly on the cutting piston or housing, for example.

According to one embodiment, the deformable member can be arranged to be plastically deformed to damp the cutting piston. In other words, irreversible deformation of the deformable member can be provided to effectively damp the cutting piston and dissipate the kinetic energy of the cutting piston. Such plastic deformation also reduces the risk of rebound of the cutting piston.

According to one embodiment, the deformable member can be arranged to be deformed (plastically and/or elastically) over at least 1 mm of stroke of the cutting piston, over at least 2 mm of stroke of the cutting piston, over at least 3 mm of stroke of the cutting piston.

According to one embodiment, the deformable member can be arranged to be deformed plastically over at least 1 mm of stroke of the cutting piston, over at least 2 mm of stroke of the cutting piston, over at least 3 mm of stroke of the cutting piston. Thus, before and after triggering the circuit breaker, the deformable member does not have the same dimensions.

According to one embodiment, the circuit breaker may have or comprise stop means to define the activated position of the cutting piston in the housing. According to one embodiment, the stop means may be separate from the deformable member, and may have no interaction with the deformable member. In other words, the stop means can be arranged at a distance from the deformable member. On the one hand, the cutting piston can be braked by the deformable member (via a first contact interface) and, on the other hand, its movement can be definitively stopped by the stop means via a second contact interface. In this way, stopping and damping are dissociated and can be better controlled.

According to one embodiment, the cutting piston can comprise at least one contact portion arranged to directly contact the deformable member, once the electrical conductor has been cut. The cutting piston has a part dedicated to contact with the deformable member, so that the damping function is repeatable.

According to one embodiment, the cutting piston may comprise at least one cutting portion arranged to directly cut the electrical conductor and wherein said at least one cutting portion is separate from said at least one contact portion and/or wherein said at least one cutting portion may be offset from said at least one contact portion with reference to the direction of movement of the cutting piston. The cutting piston has a part dedicated to contact with the deformable member, and distinct from the cutting portion, so that the cutting function and the damping function are repeatable.

According to one embodiment:
the electrical conductor can have a thickness to be cut,
in the rest position, the cutting piston can be arranged at a first distance from the electrical conductor,
in the rest position, the cutting piston can be arranged at a second distance from the deformable member,
   and the second distance can be greater than or equal to the sum of the first distance and the thickness to be cut, and preferably the second distance can be strictly greater than the sum of the first distance and the thickness to be cut. According to this embodiment, the cutting piston first touches the electrical conductor, then the deformable member.

According to one embodiment, the cutting piston may be arranged to deform the deformable member irreversibly. The kinetic energy of the cutting piston is absorbed by the irreversible deformation (plastic deformation, for example). In other words, the deformable member can be intended to deform irreversibly when the cutting piston is damped. In other words, the speed of movement imposed on the cutting piston by the pyrotechnic actuator gives the cutting piston enough energy, and the deformable member is intended to deform plastically to dissipate at least some of the kinetic energy of the cutting piston.

According to one embodiment, the deformable member may comprise a main body and at least one damping portion, and the cutting piston may be arranged to deform said at least one damping portion, and preferably only said at least one damping portion. The damping portion is intended to be deformed, so that cutting piston braking is more repeatable.

According to one embodiment,
the deformable member can comprise at least two damping portions, and preferably an even number of damping portions, preferably symmetrically distributed around the cutting piston,
the cutting piston can comprise at least two contact portions,
and said at least one cutting portion can be arranged between said at least two contact portions. The braking forces are well distributed on the cutting piston, which is not subject to overturning or jamming torque: the cutting piston movement is more repeatable.

According to one embodiment, the deformable member can be arranged to absorb heat, so as to cool the interior of the housing, which may be heated by the arcs caused by cutting and/or operation of the pyrotechnic actuator.

According to one embodiment, the deformable member can be a metal and/or porous and/or filtration body, to withstand the high temperatures generated while still being easily deformable.

According to one embodiment, the deformable member can be a part of the housing, such as a partially overmolded metal insert. The “all-in-one” design reduces manufacturing costs and/or complexity. The deformable member can be at least partially integrated into the housing. It is possible to provide a composite housing. The housing can be provided with a partitioning section to define a separation, preferably watertight, between the internal members and the outside of the circuit breaker. The housing can be designed with a deformable part that is attached, integrated or overmolded to the partitioning part. The deformable part can be formed by a metal insert which would have an anchoring part attached or overmolded to the body of the housing (the partitioning part, for example), and an active or deformable part which is located in the path of the cutting piston.

According to one embodiment, the deformable member may comprise a knitted metal and/or a compacted metal wire, to damp the cutting piston.

According to one embodiment, the housing can comprise a bearing surface arranged to provide a mechanical stop for the cutting piston and thus define the activated position. The activated position is defined robustly and reliably.

According to one embodiment, the deformable member may be arranged in the housing. The deformable member can be provided on either side of the electrical conductor, depending on the structure of the cutting piston and the part of it that will come into contact with the deformable member.

According to one embodiment, a second aspect of the invention relates to a motor vehicle, which may comprise at least one pyrotechnic circuit breaker according to the first aspect of the invention.

### DESCRIPTION OF THE FIGURES

Other features and advantages of the present invention will become more apparent upon reading the following detailed description of an embodiment of the invention, which is provided by way of example but in no manner limited thereto, and shown by the attached drawings, wherein:

FIG. 1 shows a cross sectional view of a pyrotechnic circuit breaker before triggering, in particular comprising a housing through which an electrical conductor passes, a pyrotechnic actuator, a cutting piston designed to cut the conductor when the pyrotechnic actuator is actuated or triggered, and three deformable members designed to brake the cutting piston once the conductor has been cut;

FIG. 2 shows a cross sectional view of the circuit breaker of FIG. 1 after the pyrotechnic actuator is actuated or triggered;

FIG. 3 shows an isometric view of the circuit breaker shown in FIG. 1 before the cutting piston has reached the end of its stroke and after cutting;

FIG. 4 shows a cross sectional view of the circuit breaker of FIG. 1, before the pyrotechnic actuator is actuated or triggered, and in a sectional plane perpendicular to the sectional plane shown in FIG. 1.

### DETAILED DESCRIPTION OF EMBODIMENT(S)

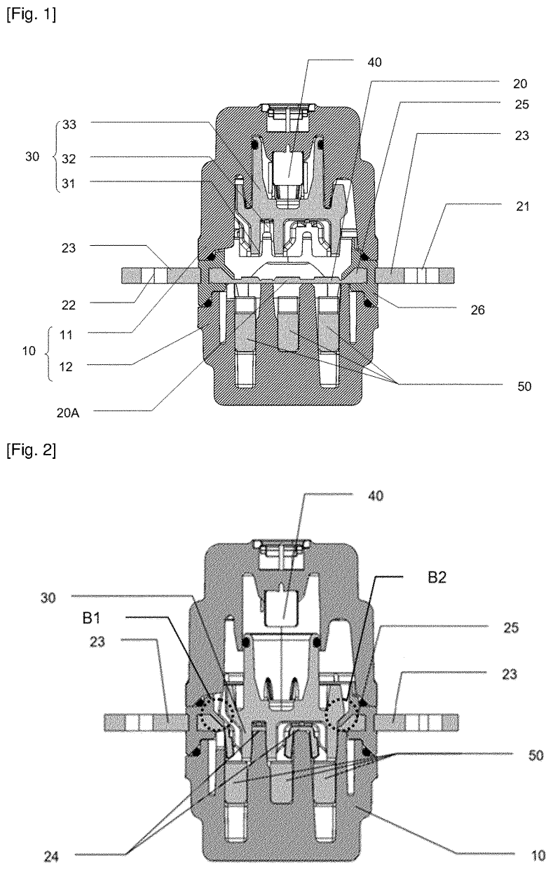

FIG. 1 shows a circuit breaker especially comprising:
a housing 10 formed by a lower housing portion 12 and an upper housing portion 11,
an electrical conductor 20 passing through the housing 10, connecting two connection terminals 21 and 22,
a pyrotechnic actuator 40 formed in this example by an electro-pyrotechnic igniter,
deformable members 50 arranged inside the housing 10,
a cutting piston 30, comprising a body 33 surrounding the pyrotechnic actuator 40 and three projections 31 on the opposite face, separated by grooves 32.

The housing 10 therefore comprises the lower housing portion 12 and the upper housing portion 11. As shown in FIG. 1, one or more seals can be provided between the lower housing portion 12, the electrical conductor 20 (in particular around an overmolded part 26 overmolded onto the electrical conductor 20) and the upper housing portion 11. The housing 10 can be made of plastic (e.g. polyamide), with reinforcing material (glass fibers), or even with metal inserts.

As regards the electrical conductor 20, two inner ends 25 define the edges of a portion to be cut 20A of the electrical conductor 20. Between the two inner ends 25, the electrical conductor 20 is in contact with returns on the lower housing 12, forming matrices.

In FIG. 1, the cutting piston 30 occupies a rest position, facing the portion to be cut 20A of the electrical conductor 20. In particular, the three projections 31 are positioned at a predetermined distance a (shown in FIG. 4) from the portion to be cut 20A of the electrical conductor 20.

Three deformable members 50 are housed in the lower housing 12, at a predetermined distance b (shown in FIG. 4) from the electrical conductor 20.

FIG. 1 shows a space between the pyrotechnic actuator 40 and the body 33 of the cutting piston 30, forming a combustion chamber. In addition, a space between the cutting piston 30 and the portion to be cut 20A and a space between the portion to be cut 20A and the deformable members 50 form a cutting chamber. The combustion and cutting chambers are sealed from one another by a seal mounted on the cutting piston 30.

FIG. 2 shows the circuit breaker of FIG. 1 after the electrical conductor 20 has been disconnected, with the cutting piston 30 in an activated position: under the pressure generated by hot gases generated by the pyrotechnic actuator 40, the cutting piston 30 has moved downwards in the housing 10 of FIG. 2 to occupy the activated position shown.

During the movement of the cutting piston 30, the electrical conductor 20 has been cut into at least four distinct parts (two distinct lateral portions 23, each with an internal end 25, and at least two central portions 24).

It can be seen in FIG. 2 that the cutting piston 30 is in mechanical abutment with the overmolded part 26, so that the activated position of the cutting piston in FIG. 2 is precisely defined. In particular, two inclined portions B1 and B2 provide the mechanical stop for the cutting piston 30 on the housing 10. It may be noted that the inclined portions B1 and B2 are distinct and separate from the deformable members 50.

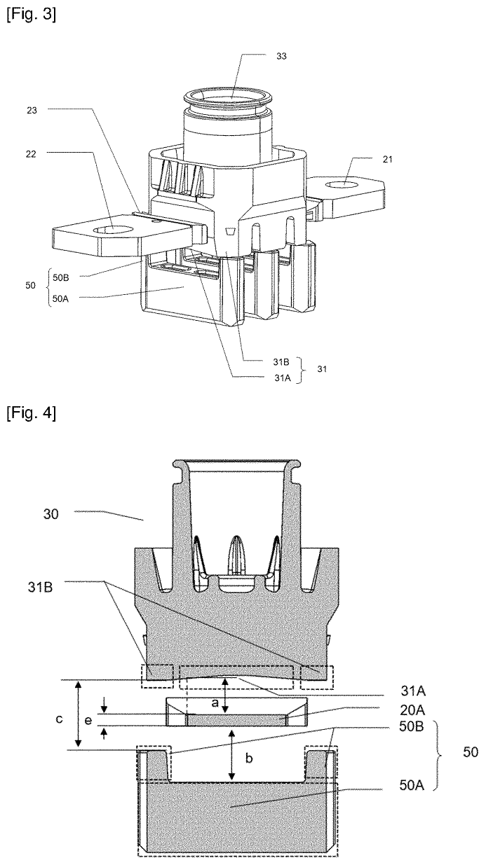

FIG. 3 shows a partial view of the circuit breaker before the cutting piston 30 reaches the activated position shown in FIG. 2, and shows only the cutting piston 30, part of the electrical conductor 20 and the deformable members 50, once the electrical conductor 20 has been severed and before the deformable members 50 have been deformed.

It may be noted that the three projections 31 of the cutting piston 30 are each composed of a cutting portion 31A designed to cut, shear or slice the electrical conductor 20 and two contact portions 31B, each designed to come into contact with a damping portion 50B of each deformable member 50.

Each deformable member 50 therefore comprises a main body forming a cooler portion 50A, designed to cool the air in the circuit breaker cutting chamber, and two damping portions 50B, deformable (preferentially irreversibly) and adjacent to the cooler portion 50A. The damping portions 50B are offset relative to the cooler portion 50A in the direction of movement of the cutting piston 30, so that the cutting piston 30 comes into contact with the damping portions 50B and not with the cooler portion 50A, on reaching the activated position shown in FIG. 2. This makes it possible to adjust the damping of the cutting piston 30 more precisely and thus ensure that the stroke of the cutting piston 30 after cutting the electrical conductor 20 is sufficient and controlled to guarantee a current cut.

The deformable member 50A can be formed as a metal and/or porous and/or filter body, comprising a knitted metal and/or compacted metal wire. Wire with a diameter of between 0.2 mm and 1.5 mm can be used.

FIG. 4 shows a cross sectional view of the circuit breaker shown in FIG. 1, passing through the cutting piston 30 and a deformable member 50. FIG. 4 shows the circuit breaker before triggering, with the cutting piston in the rest position. Of particular note are:
the predetermined distance a between the cutting portion 31A of the cutting piston 30 and the portion to be cut 20A of the electrical conductor 20,
the predetermined distance b between the electrical conductor 20 and the cooler portion 50A of the deformable member 50,
a predetermined distance c between the contact portions 31B of the cutting piston 30 and the damping portions 50B of the deformable member 50.

If e is the thickness of the portion to be cut 20A, it may be noted that:

c>a

In other words, the circuit breaker is designed so that the cutting portion 31A comes into contact with the portion to be cut 20A before the contact portions 31B come into contact with the damping portions 50B.

The operation of the circuit breaker will now be explained in detail.

If the need for rapid cutting of the electrical conductor 20 is identified, the pyrotechnic actuator 40 is triggered and high pressure is generated in the combustion chamber (the space between the pyrotechnic actuator 40 and the cutting piston 30), pushing the cutting piston 30 from the rest position shown in FIG. 1 to the activated position shown in FIG. 2.

During this movement, the cutting piston 30 first covers a free stroke of predetermined length a (the distance between the projections 31 and the portion to be cut 20A in FIG. 4), between its rest position and a contact position with the electrical conductor 20. Once in the contact position, the electrical conductor 20 is cut by the cutting piston 30, for example by mechanical shearing.

As shown in FIG. 1, the projections 31, separated by grooves 32, form knives to cut the part to be cut 20A. As the cutting piston 30 moves from the rest position to the activated position, the projections 31 on the cutting piston 30 bear on the unsupported parts of the electrical conductor 20, shearing it off at the part to be cut 20A. As shown in FIG. 2, shearing of the electrical conductor 20 leads to the formation, after opening, of the two distinct central electrical conductor portions 24 (visible in FIG. 2), separated from the rest of the electrical conductor 20, in particular the discrete lateral portions 23.

Furthermore, at the very start of opening, when the inner ends 25 are still close to the central portions 24, an electric arc can form between each inner end 25 and a central portion 24 if the pyrotechnic circuit breaker has electric current flowing through it. During the movement of the cutting piston 30 from the rest position to the activated position, the cutting piston 30 pushes and causes each discrete lateral portion 23 to bend, so that the electric arc travels an arc path that “stretches” or “elongates” in order to present at the end of operation a sufficient free distance to guarantee an electric arc extinguishing and cutting of the electric current that was initially passing through the electrical conductor 20.

After leaving the contact position and starting to cut or section the electrical conductor 20, the cutting piston 30 continues an undamped stroke (equal to c-a-e) before being braked by the damping portions 50B of the deformable member 50 which come into contact with the contact portions 31B of the cutting piston 30. As a result, the damping portions 50B will absorb the kinetic energy of the cutting piston 30, progressively deforming irreversibly.

FIGS. 1, 2 and 4 show that, whatever the position of the cutting piston 30, a positive clearance is left between the electrical conductor 20 and the deformable member 50. In particular, it can be seen in FIG. 4 that the electrical conductor 20 is remote from the deformable body 50, and when cutting the electrical conductor 20, the two parts do not touch and no additional force to the cutting force of the electrical conductor 20 is required.

The undamped stroke (after cutting) and the clearance between the electrical conductor 20 and the deformable member 50 mean that the cutting piston 30 does not begin to be slowed down by the deformable member 50 until the electrical conductor 20 has been completely severed, thus cutting the electrical conductor 20 at high speed and minimizing the “stretching” and “elongation” of the aforementioned arcs. Cutting the electrical conductor 20 and breaking the electrical circuit is therefore quick and repeatable.

The cutting piston 30 is therefore mounted in a sliding or translational connection with respect to the housing 10 and slides during its movement from the rest position to the activated position, which provides a reproducible, controlled operation and activated position in order to guarantee rapid cutting and arc extinguishing at the end of operation. However, the step of cutting with electric arcs can generate hot gases that need to be cooled. To this end, the deformable members have cooler portions 50A (visible in FIGS. 1 to 4). In this way, the structure of the circuit breaker can be kept simple, with the deformable member performing two functions with distinct parts:
the damping of the cutting piston 30 with the damping portions 50B,
gas cooling, with the cooler portions 50A.

It may also be noted that the damping portions 50B “surround” the electrical conductor 20, so that the damping forces on the cutting piston 30 are well distributed, limiting the risk of jamming. In other words, the damping portions 50B are distributed on either side of the electrical conductor 20 and/or the cutting piston 30.

### Industrial Application

A circuit breaker according to the present invention, and its manufacture, are capable of industrial application.

It will be understood that various modifications and/or improvements which are obvious to a person skilled in the art may be made to the different embodiments of the invention described in the present description without departing from the scope of the invention. In particular, separate components can be provided for cooling and damping. For example, damping portions can be integrated into the housing 10 (with deformable lugs, for example, or an overmolded insert with a portion protruding into the cutting chamber, etc.).

1-19. (canceled)

20. A pyrotechnic circuit breaker, comprising at least:
a housing,
an electrical conductor to be cut, at least partially passing through the housing,
a cutting piston, housed in the housing and movable between a rest position and an activated position, the cutting piston being arranged to cut the electrical conductor during its movement from the rest position to the activated position,
a pyrotechnic actuator, housed in the housing and arranged to change the cutting piston from the rest position to the activated position during its operation,
wherein the circuit breaker comprises at least one deformable member, arranged to brake the cutting piston once the electrical conductor is cut,
and in that a strictly positive clearance is provided between the deformable member and the electrical conductor before it is cut.

21. The pyrotechnic circuit breaker according to claim 20, wherein the cutting piston passes through a contact position during its movement from the rest position to the activated position, wherein the contact position is a position wherein the cutting piston is in contact with the electrical conductor before being cut, and wherein a strictly positive clearance is provided between the deformable member and the cutting piston in the contact position.

22. The pyrotechnic circuit breaker according to claim 21, wherein the strictly positive clearance provided between the deformable member and the cutting piston in the contact position is a clearance strictly greater than a thickness (e) to be cut of the electrical conductor.

23. The pyrotechnic circuit breaker according to claim 20, wherein the cutting piston travels:
a free stroke before cutting the electrical conductor and
a damped stroke during which the deformable member is deformed,
and wherein a ratio of the free stroke to the damped stroke is greater than or equal to 1.2, and preferably greater than 1.5.

24. The pyrotechnic circuit breaker according to claim 20, wherein the cutting piston travels:
a non-damped stroke after having cut the electrical conductor and
a damped stroke during which the deformable member is deformed,
and wherein a ratio of the non-damped stroke to the damped stroke is greater than or equal to 0.6, and preferably greater than 0.75 and even more preferentially greater than 0.85.

25. The pyrotechnic circuit breaker according to claim 20, wherein the deformable member is arranged to be deformed directly by the cutting piston.

26. The pyrotechnic circuit breaker according to claim 20, wherein the cutting piston comprises at least one contact portion arranged to directly contact the deformable member once the electrical conductor is cut.

27. The pyrotechnic circuit breaker according to claim 26, wherein the cutting piston comprises at least one cutting portion arranged to directly cut the electrical conductor and wherein said at least one cutting portion is separate from said at least one contact portion and/or wherein said at least one cutting portion is offset from said at least one contact portion with reference to the direction of movement of the cutting piston.

28. The pyrotechnic circuit breaker according to claim 20, wherein:
the electrical conductor has a thickness to be cut,
in the rest position, the cutting piston is arranged at a first distance from the electrical conductor,
in the rest position, the cutting piston is arranged at a second distance from the deformable member,
and wherein the second distance is greater than or equal to the sum of the first distance and the thickness to be cut, and preferably the second distance is strictly greater than the sum of the first distance and the thickness to be cut.

29. The pyrotechnic circuit breaker according to claim 20, wherein the cutting piston is arranged to deform the deformable member irreversibly.

30. The pyrotechnic circuit breaker according to claim 20, wherein the deformable member comprises a main body and at least one damping portion, and wherein the cutting piston is arranged to deform said at least one damping portion, and preferably only said at least one damping portion.

31. The pyrotechnic circuit breaker according to claim 30,
wherein the cutting piston comprises at least one cutting portion arranged to directly cut the electrical conductor and wherein said at least one cutting portion is separate from said at least one contact portion and/or wherein said at least one cutting portion is offset from said at least one contact portion with reference to the direction of movement of the cutting piston,
wherein the deformable member comprises at least two damping portions, and preferably an even number of damping portions, preferably symmetrically distributed around the cutting piston,
wherein the cutting piston comprises at least two contact portions,
and wherein said at least one cutting portion is arranged between said at least two contact portions.

32. The pyrotechnic circuit breaker according to claim 20, wherein the deformable member is a metal and/or porous and/or filtration body.

33. The pyrotechnic circuit breaker according to claim 20, wherein the housing comprises a bearing surface arranged to provide a mechanical stop for the cutting piston and thus define the activated position.

34. A motor vehicle, comprising at least one pyrotechnic circuit breaker according to claim 20.
